(19) United States
(12) Patent Application Publication
(10) Pub. No.: US 2011/0263407 A1
(43) Pub. Date: Oct. 27, 2011

(54) Efficiency of centrifuge in municipal sludge dewatering

(76) Inventor: John Jee Ho Jew, Toronto (CA)

(21) Appl. No.: 12/662,629

(22) Filed: Apr. 27, 2010

(51) Int. Cl. B04B 1/20; B04B 11/04; C02F 11/00

(52) U.S. Cl. 494/6; 210/603; 494/37

(57) ABSTRACT

In a sludge dewatering system, digested sludge with polymer solution added to promote flocculation is delivered to, and fills a treatment tank to a predetermined level The sludge is then agitated to liberate contained gases, and low vacuum of no more than 20 inches of Hg below ambient air pressure is applied to a zone in the tank above the sludge to remove gases and to assist in degassing the sludge. The sludge is then delivered to the centrifuge, preferably a decanter-type, where solids recovery rates can approach 99.5%.

### BACKGROUND OF THE INVENTION

1. The invention relates generally to municipal wastewater treatment, and, more specifically, to improving the efficiency with which a decanter-type centrifuge separates solids from water in polymer-added municipal digested sludge.

2. Municipal sludge dewatering processes and equipment are well known. Examples may be found in U.S. Pat. No. 1,757,262 to Sims; U.S. Pat. No. 1,757,263 to Sims; U.S. Pat. No. 2,360,811 to Kelly; U.S. Pat. No. 3,219,579 to Kranz; U.S. Pat. No. 3,513,971 to Wicdahl; U.S. Pat. No. 4,717,484 to Kauffer; U.S. Pat. No. 6,171,508 to Browning Jr.; U.S. Pat. No. 6,224,772 to Golcz; U.S. Pat. No. 6,254,776 to Seagle; and U.S. Pat. No. 6,319,398 to Saitoh.

Municipal sludge that settles from municipal sewage is commonly transferred to primary digester tanks. After mixing, and being partially digested, because of health concerns and odor problems, the sludge from the primary digester tanks is usually further stabilized in secondary, anaerobic, digester tanks for an extended period, as much as 15, or more days. When substantially stabilized, the sludge is then dewatered to ease subsequent handling and disposal.

Various devices are known for the dewatering of sludge, including vacuum filters, belt filters, plate press filters, and centrifuges.

In spite of being relatively expensive, centrifuges have been increasingly used for sludge dewatering because of their comparative simplicity of installation, operation and maintenance.

However, a major problem with sludge centrifugation is the often low efficiency at which the centrifuge dewaters sludge, especially anaerobically digested sludge.

It is known that poor settling of sludge in settling ponds and sludge tanks is caused by gases in the sludge, and in the prior art attempts were made to evacuate the gases in order to facilitate settling. It is not known, however, as to the cause or causes of, or solution to, the often low capture rate of the centrifuge dewatering of sludge.

The present invention is directed to solving this problem.

### BRIEF SUMMARY OF THE INVENTION

In one aspect, in a sludge dewatering process, the present invention provides a pre-centrifuge treatment method that improves the efficiency with which a decanter-type centrifuge separates solids from water in digested sludge.

The method involves delivering polymer-added sludge to a tank until a predetermined sludge level is achieved while leaving an empty gas collection zone above the sludge. Through the use of a conventional open/closed valve, the tank is vented to the atmosphere when being filled, and closed to the atmosphere when the predetermined level is reached. The sludge is then agitated, as with a rotating horizontal blade. During such agitation, vacuum is applied to the empty zone of the tank to remove gases already liberated and to induce liberation of gases still remaining in the sludge.

The sludge is then delivered to the centrifuge where separation of solids from water in the sludge is greatly enhanced.

The present invention thus provides in a sludge processing system, a method of improving the efficiency of centrifugal separation of solids from water in sludge, the method comprising the steps of delivering the sludge to a treatment tank; filling the tank to a predetermined level while leaving a gas collection zone above the predetermined level; and, (a) agitating the sludge to liberate gases contained in the sludge, and (b) applying vacuum to the gas collection zone of the tank during the agitating step to remove the gases; delivering the treated sludge from the tank to a centrifuge, and centrifuging the treated sludge.

The sludge going into the treatment tank is preferably digested sludge.

The sludge agitating step involves substantially vertical turbulent displacement of the sludge within the tank.

The vacuum applying step involves applying low vacuum.

The low vacuum consists of not more than twenty inches of mercury below ambient atmospheric pressure.

The system includes the step of introducing a polymer solution into the digested sludge, to promote flocculation of the particulates. The polymer solution is introduced to the sludge prior to entry within the tank.

The present sludge processing system thus includes transferring the digested sludge to a treatment tank; simultaneously adding a polymer solution to the sludge, to promote flocculation of the sludge; partially filling the treatment tank while leaving a gas collection zone above the sludge; agitating the sludge to liberate gases contained in the sludge; applying low vacuum to the gas collection zone of the tank to remove the gases; delivering the treated sludge from the tank to a decanter-type centrifuge, and centrifuging the sludge to separate the solids of the sludge from water.

The present invention thus includes a sludge pre-centrifuge treatment apparatus for increasing the capture of solids in a digested sludge obtained from a sludge source, consisting of a sludge pump connecting the sludge source through a supply line to a sludge treatment tank; polymer solution with injection means connected to the supply line, to inject polymer solution into the digested sludge; sludge pump control means to limit the level of digested sludge within the tank and to preserve a gas extraction zone within the tank above the digested sludge; a vacuum pump connecting the gas extraction zone to atmosphere, to maintain a low vacuum in the treatment tank; motor driven stirring means extending within the treatment tank in immersed relation with the sludge, to stir the sludge and to promote the liberation of gas from the sludge; an outlet from the treatment tank connecting with a decanter-type centrifuge, to transfer substantially de-gassed sludge to the centrifuge for separation of solids from the sludge, and to discharge them as cake and liquid centrate from the centrifuge.

The sludge pre-centrifuge treatment apparatus includes a stop/go control valve at the tank outlet, and a sludge pump interposed between the control valve and the centrifuge, to transfer the deaerated sludge to the centrifuge.

The apparatus includes a vacuum pump control to limit the low vacuum to not more than 20″ Hg below ambient atmospheric pressure.

It has been found that it is not necessary to apply high vacuum to remove the liberated gases, and that low vacuum, in the order of about 20 inches of mercury (20″ Hg) below ambient air pressure achieves the desired result.

It has been discovered that no meaningful benefit is obtained by using a higher degree of vacuum.

As a comparison, without the pretreatment method of the invention, as little as 50% of the solids may be recovered by such centrifuging. Using the above described preliminary treatment process, centrifuge recovery rates for solids can approach 99.5%. In another aspect, the present invention provides apparatus for use in conjunction with a centrifuge in dewatering digested sludge. The apparatus includes a tank that can be opened or closed to atmosphere by means of a valve, and means for delivering sludge to the tank.

Flow control means are provided for terminating delivery of sludge when the tank has been filled to a predetermined level, leaving a normally empty zone at the top of the tank. Controllable agitating means are provided to agitate the sludge, encouraging the release of gases from the sludge, and controllable vacuum means are connected with the empty zone of the tank to liberate and remove gases.

Controllable delivery means transfer the sludge after preliminary processing to a centrifuge to separate the residues from water.

Other aspects of the invention will be apparent from a description below of a preferred embodiment and will be more specifically defined in the appended claims.

### BRIEF DESCRIPTION OF THE SEVERAL VIEWS OF THE DRAWINGS

Certain embodiments of the invention are illustrated by way of example, without limitation of the invention thereto, other than as set forth in the accompanying claims; it being understood that further embodiments may be derived by one skilled in the art. Reference is made to the accompanying drawings, wherein:

FIG. 1 is a schematic side elevation of the apparatus in accordance with the present invention; and,

FIG. 2 is a block diagram showing the steps of the subject sludge dewatering process.

### DETAILED DESCRIPTION OF THE INVENTION

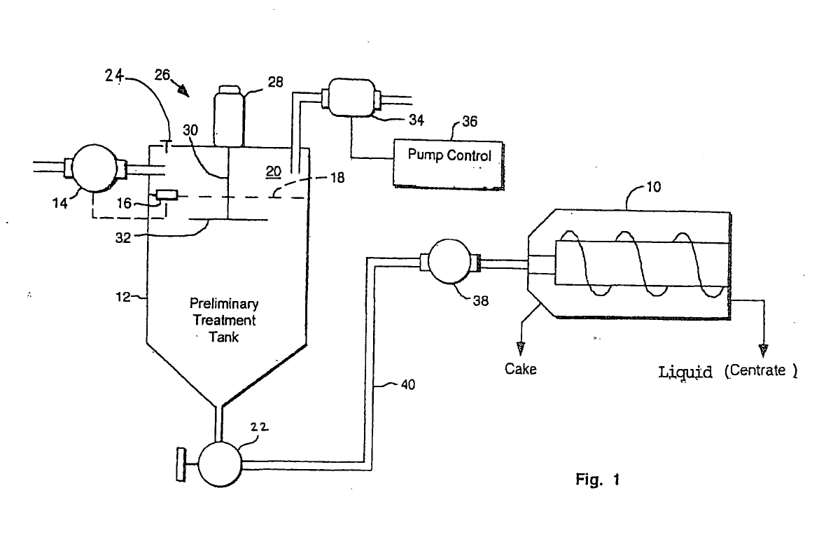

Reference is made to FIG. 1 which illustrates sludge pre-treatment equipment adapted to improve the separation of solids from water in digested sludge in a centrifuge 10. The equipment includes a preliminary treatment tank 12. Tank 12 has on top an open or closed valve 24 that can be opened to the atmosphere to allow filling of the tank, and closed when evacuation of the tank is started.

A pump 14 delivers sludge from an upstream source (not shown), such as a secondary digester or blending tank, to the tank 12. The sludge pump 14 is controlled by a float valve 16 or other conventional level sensor means to stop the pump 14 when the sludge has risen to a prescribed level 18 (indicated with a dashed line), leaving empty a gas collection zone 20 at the top of the tank 12.

A discharge valve 22 located at the bottom of the tank 12 is closed to retain the sludge until transfer to the centrifuge 10 is required.

A stirring mechanism 26 is mounted to the top of the pre-centrifuge treatment tank 12. The mechanism 26 includes an electric motor 28, a vertical shaft 30 driven by the motor 28, and a horizontally oriented twisted blade 32 centrally fixed to the rotary shaft 30. The blade 32 is immersed in the sludge, below the surface level 18.

In practice, the blade may be rotated at a speed of 60 rotations per minute, agitating the contents of the tank 12. This stirring action liberates gases contained in the sludge that would otherwise interfere with the separation of the particulates from water in the sludge in centrifuge 10. A vacuum pump 34 is coupled to the empty gas collection/extraction zone 20 at the top of the tank 12, and extracts the liberated gases.

A conventional pump controller 36 operates the pump 34 to maintain a low vacuum of 20 inches of mercury (Hg) below atmospheric pressure, while the sludge is being agitated.

Another sludge pump 38 couples the treatment tank 12 to the centrifuge 10. A conduit 40 connects the intake port of the sludge pump 38 in communication with the interior of tank 12, through the discharge valve 22, for removal of sludge conditioned for the centrifuge 10. The centrifuge 10 then separates solids from water in the sludge, discharging cake (biosolids), and liquid centrate.

The duration of agitation is dependent on the volume of sludge involved, the speed of rotation of the rotary blade 32, and the gas content of the sludge.

A good measure of whether the sludge has been sufficiently pre-treated is to perform a conventional sludge settling test in a graduated cylinder: the more settling of the sludge observed, the greater the efficiency that will be observed during recovery of residues in the centrifuge 10.

As mentioned above, the preliminary treatment process provides recovery rates approaching 99.5%, far exceeding what can be currently obtained from prior art processes for centrifugation of secondary digested sludge.

Because of the greater recovery, much less solids is returned to the system for reprocessing, thereby saving greatly on energy and chemicals.

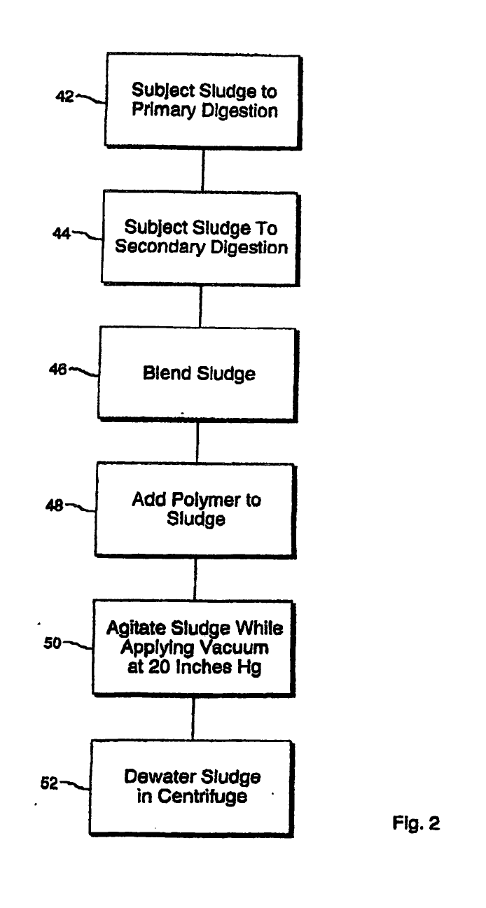

The pre-centrifuge treatment equipment may be better understood in the context of a complete sludge dewatering process as diagrammatically illustrated in FIG. 2.

In FIG. 2, sludge, in a two stage sludge digestion process, is initially passed through a primary digester tank, as at step 42, to encourage mixing and decomposition of the sludge. The sludge is then delivered to secondary digester tank, as at step 44, where the sludge is subjected to further decomposition for an extended period.

The digested sludge is then delivered to a conventional blending tank, as at step 46 where the sludge is thoroughly blended to a relatively uniform consistency.

A conventional polymer solution, formulated to encourage flocculation of particulates in sludge, is added to the sludge, as indicated at step 48. The polymer is added while the sludge is conveyed in the pipes between the blending tank and the preliminary treatment tank. The digested sludge, now blended and containing polymer solution, is delivered to the preliminary treatment tank 12 where, as indicated at step 50, the sludge is agitated to liberate gases contained in the sludge, and vacuum is applied to the tank 12 to remove such gases and to encourage further liberation of gases. The sludge is then delivered from the tank 12 to the centrifuge 10 which is operated during such delivery to separate solids (cake), from water (centrate), as indicated at step 52, while sludge passes through the centrifuge 10.

The pre-treatment process of the invention and its associated apparatus may be used with various types of centrifuges, such as basket-type, disc-type and decanter-type but decanter-type, also called “solid-bowl” centrifuges are preferred.

A number of points should be noted. The process of this invention may be used with sludge that has passed through a primary digester only.

Primary digestion does not appear to impair centrifugation as severely as secondary digestion, and the reason is believed to be the greater conversion of volatile solids to gases with extended decomposition of the sludge during secondary digestion.

The invention provides much greater advantage when used with sludge that has been subjected to secondary digestion. And in this sense, this invention is also applicable to food, fruit, farm or brewery wastes that has gone through anaerobic digestion.

The point of polymer addition is not crucial. The polymer could be added to the sludge even after the preliminary treatment tank, as long as sufficient time is allowed for the polymer and sludge reaction to occur before centrifugation takes place.

It will be appreciated that particular embodiments of the invention have been described and that modifications may be made therein without necessarily departing from the scope of the appended claims.

### SLUDGE DEWATERING PARTS LIST—FIG. 1

10 centrifuge
12 preliminary treatment tank
14 sludge pump (to the tank)
16 float valve
18 preselected fill level
20 gas collection zone/empty zone/gas extraction zone
22 discharge valve
24 open/close valve
26 stirring mechanism
28 motor (stirring mechanism)
30 vertical shaft (stirring mechanism)
32 horizontal blade (stirring mechanism)
34 vacuum pump
36 pump controller
38 pump (to centrifuge)
40 conduit

### PROCESS STEPS PARTS LIST—FIG. 2

42 primary digestion
44 secondary digestion
46 blending
48 add polymer
50 agitate-pretreatment
52 centrifuge sludge to cake and liquid centrate

I claim:

1. In a sludge processing system, a method of improving the efficiency of centrifugal separation of solids from water in digested sludge, the method comprising the steps of:
delivering said digested sludge to a treatment tank; filling said tank to a predetermined level while leaving a gas collection zone above said predetermined level;
(a) agitating said sludge to liberate gases contained in the sludge, and (b) applying vacuum to said gas collection zone of the tank during said agitating step to remove said gases; and delivering the treated sludge from the tank to a centrifuge.

2. The system as set forth in claim 1, wherein said sludge is digested sludge.

3. The system as set forth in claim 1, wherein said agitating step involves substantially vertical turbulent displacement of said sludge within said tank

4. The system as set forth in claim 2, wherein said agitating step involves substantially vertical turbulent displacement of said sludge within said tank

5. The system as set forth in claim 1, wherein said vacuum applying step involves low vacuum.

6. The system as set forth in claim 5, wherein said low vacuum is not more than twenty inches of mercury below ambient atmospheric pressure.

7. The system as set forth in claim 2, including the step of introducing a polymer solution into said digested sludge, to promote flocculation of said particulates.

8. The system as set forth in claim 7, wherein said polymer solution is introduced to said sludge prior to entry of said sludge within said tank

9. In a sludge processing system, a method of improving the efficiency of centrifugal separation of digested sludge comprising the steps of transferring said digested sludge to a treatment tank; simultaneously adding a polymer solution to said sludge, to promote flocculation of the sludge; partially filling the treatment tank while leaving a gas collection zone above the sludge; agitating the sludge to liberate gases contained in the sludge; applying low vacuum to said gas collection zone of the tank to remove said gases; delivering the treated sludge from the tank to a decanter-type centrifuge, and centrifuging said sludge to separate the solids of said sludge to a cake and liquid concentrate.

10. A sludge pre-centrifuge treatment apparatus for increasing the capture rate of solids in a digested sludge obtained from a sludge source, consisting of a sludge pump connecting said sludge source through a supply line to a sludge treatment tank, to transfer digested sludge to said treatment tank; polymer solution supply injection means connected to said supply line, to inject polymer solution into said digested sludge; sludge pump control means to limit the level of said digested sludge within said tank and preserve a gas extraction zone within the tank above said digested sludge; a vacuum pump connecting said gas extraction zone to atmosphere, to maintain a low vacuum in said treatment tank; motor driven stirring means extending within said treatment tank in immersed relation with said sludge, to stir said sludge and promote separation of gas from said sludge; an outlet from said treatment tank connecting with a decanter-type centrifuge, to transfer substantially de-gassed sludge to said centrifuge for separation of solids from said sludge, and discharge as a cake and liquid centrate from said centrifuge.

11. The sludge treatment apparatus as set forth in claim 10, including a stop/go control valve at said treatment tank outlet, and a sludge pump interposed between said control valve and said centrifuge, to transfer said deaerated sludge to said centrifuge.

12. The sludge treatment apparatus as set forth in claim 10, including a vacuum pump control to limit said low vacuum to not more than 20″ Hg below ambient atmospheric pressure.
